(19) United States
(12) Patent Application Publication
(10) Pub. No.: US 2018/0086172 A1
(43) Pub. Date: Mar. 29, 2018

(54) Roll Stabilizer for a Multitrack Motor Vehicle

(71) Applicants: Schaeffler Technologies AG & Co. KG, Herzogenaurach (DE); Dr. Ing. H.C.F. Porsche Aktiengesellschaft, Stuttgart (DE)

(72) Inventors: Wilfried Breton, Altdorf (DE); Mario Arnold, Aurachtal (DE); Ramon Jurjanz, Erlangen (DE); Dustin Knetsch, Erlangen (DE); Markus Holzberger, Emskirchen (DE); Silvia Kutzberger, Erlangen (DE); Thorsten Koch, Schwieberdingen (DE); Igor Illg, Renningen (DE)

(21) Appl. No.: 15/562,433

(22) PCT Filed: Mar. 17, 2016
(86) PCT No.: PCT/DE2016/200145

§ 371 Date: Sep. 28, 2017

(30) Foreign Application Priority Data
Apr. 2, 2015 (DE) 10 2015 206 064.0

(51) Int. Cl. B60G 21/055

(52) U.S. Cl. CPC B60G 21/0558; B60G 2600/44; B60G 2800/012

(57) ABSTRACT

A roll stabilizer, e.g., for a multitrack motor vehicle, with a divided torsion bar, between the mutually facing ends of which an actuator is arranged for transmission of a torsion moment. The actuator may have a housing which is connected to the one torsion bar part and houses a motor and a planetary gear mechanism connected to the motor, the gear output of which is connected to the other torsion bar part. and the planet wheels of which intermesh with a mating gear. A multistage planetary gear mechanism is provided, whose final planetary gear stage on the gear output side is equipped with planet wheels, wherein at least one of said planet wheels is divided into two axially adjacent spur gears which are rotatable relative to each other and between which a torsion spring is actively arranged. The divided planet wheel may be in play-free engagement with the mating gear.

### CROSS-REFERENCE TO RELATED APPLICATIONS

This application is the U.S. National Phase of PCT Appln. No. PCT/DE2016/200145 filed Mar. 17, 2016, which claims priority to DE 102015206064.0 filed Apr. 2, 2015, the entire disclosures of which are incorporated by reference herein.

### TECHNICAL FIELD

The present disclosure concerns a roll stabilizer, for example, for a multitrack motor vehicle. Such roll stabilizers may counter a rolling of the vehicle superstructure on cornering.

### BACKGROUND

DE102009006385 discloses a roll stabilizer.

Such roll stabilizers for multitrack motor vehicles are configured as active stabilizers and equipped with a divided torsion bar, between the mutually facing ends of which an actuator is arranged for transmission of a torsion moment. The actuator has a housing which is connected to the one torsion bar part and houses a motor and a planetary gear mechanism connected to the motor, the gear output of which is connected to the other torsion bar part, wherein planet wheels of the planetary gear mechanism intermesh with a mating gear.

In such active roll stabilizers, disruptive rattling noises are observed in operation, which are transmitted as body-borne sound to the passenger compartment and perceived as unpleasant. An object of the present disclosure is to specify a roll stabilizer in operation of which these disadvantageous rattling noises are reduced.

### SUMMARY

The disclosure achieves this object with a roll stabilizer according to embodiments described herein and the Figures.

The roll stabilizer according to the disclosure for a multitrack vehicle is provided with a divided torsion bar, between the mutually facing ends of which an actuator is arranged for transmission of a torsion moment. Such actuators can actively build up a torque taking into account driving data, such as transverse acceleration and tilt of the vehicle superstructure, and introduce it into a torsion bar in order to actively counter any rolling.

The actuator may have a housing which is connected to one torsion bar part and houses a motor and a planetary gear mechanism connected to the motor. The motor may for example be an electric motor. The motor may have a drive pinion which meshes with a gear wheel of the planetary gear mechanism. The planetary gear mechanism according to the disclosure may be configured in multiple stages. Multistage planetary gear mechanisms have several planetary gear stages connected in series, wherein the final planetary gear stage is arranged on the gear output side.

The gear output of the planetary gear mechanism is connected to the other torsion bar part. The planet wheels mesh with a mating gear. Ring gears and sun wheels are normally used as mating gears in a planetary gear mechanism.

At least one of the planet wheels on the final planetary gear stage may be divided into two axially adjacent spur gears which are rotatable relative to each other and between which a torsion spring is actively arranged, such that the divided planet wheel is in play-free engagement with the mating gear. These divided planet wheels, in the same way as one-piece planet wheels, transmit operating loads which occur in operation of the roll stabilizer. The above-mentioned conventional roll stabilizer is provided with one-piece planet wheels. A toothing play exists in the engagement of the planet wheels with the ring gear and the sun wheel. This means that under a load change, e.g., for example as a result of a contra-directional torque applied by the actuator, the load transmission switches from the one tooth flank to the other tooth flank of the meshing teeth of the planet wheel. It has been found that on a load change, the meshing teeth knock against the teeth of the mating gear and cause the undesirable noise.

According to the disclosure, the pretensioned torsion spring ensures that the engagement of the divided planet wheel in the mating gear remains play-free. If now for example the initially load-free gear mechanism is subjected to a moment, the pretensioned spur gears twist further against each other until the tooth flanks of the teeth of both spur gears lie against the teeth of the mating gear. The tooth of the one spur gear which is initially not in contact thus also comes to rest on the tooth of the mating gear, increasing the stored spring energy. In this situation, the torsion spring is loaded to the maximum moment. This energy is now stored in the spring and reduces the impulse with which the tooth flanks of the mating gear and planet wheel can impact on each other. This effect is achieved by targeted matching of the spring stiffness and spring travel of the torsion spring. The spring travel may be set using the toothing play. On a load change, the spring force of the pretensioned torsion spring is reduced when the two spur gears of the planet wheel twist. This play-free engagement of the planet wheel according to the disclosure exists with both the ring gear and the sun wheel.

According to the disclosure, a multistage planetary gear mechanism may be provided, the final planetary gear stage of which located on the gear output side is equipped with at least one of the divided planet wheels. This planetary gear stage can transmit the greatest forces within the planetary gear mechanism, and consequently has the largest planet wheels which can be produced at acceptable production cost as divided and pretensioned planet wheels. It has been found that an undesirable noise formation is suppressed particularly effectively if at least one of the planet wheels of the final planetary gear stage is configured as a divided pretensioned planet wheel. In multistage planetary gear mechanisms, according to the disclosure it may be economically favorable to equip only the final planetary gear stage with at least one of these divided planet wheels. However, it may be suitable to configure several or all planet wheels of the final stage as pretensioned divided planet wheels; this may be useful if very large torsion forces are active and the torsion springs of the divided planet wheels are therefore under very heavy load; if several pretensioned planet wheels are in engagement, the load can be distributed over several planet wheels.

The torsion spring may ensure that under a torsion moment, firstly a tooth of the one spur gear lies against a tooth of the mating gear delimiting a tooth gap, and secondly a tooth of the other spur gear lies against the other tooth of the mating gear delimiting the tooth gap. This situation exists when the planetary gear mechanism is load-free. Under operating load, a relative twist of the two spur gears of the intermeshing planet wheels takes place in the manner described.

The mating gear may be formed by a ring gear connected rotationally fixedly to the housing. The known active roll stabilizers may for example transmit the knocking noise of the teeth of the planet wheels on a load change to the housing as body-borne sound, and from there into the passenger compartment via parts connecting the active roll stabilizer to the vehicle superstructure. In one embodiment, this disadvantage is excluded or at least largely compensated.

In one embodiment, the planet wheels are mounted rotatably in a planet carrier and are all configured as divided planet wheels. In this way, the impulse-damping forces of the plurality of torsion springs are cumulated, so that under a load change, disruptive rattling noises can be excluded.

It has been found that a torsion spring formed as a circular ring segment with peripheral spring ends is advantageous; between the ends of the spring, a slot is formed in which two cams engage which are each assigned to one of the two spur gears, wherein the one cam is assigned to one of the two spring ends and the other cam is assigned to the other spring end. The springs are small in structure and, because of their compact construction, are easy to arrange between the two spur gears.

Said two cams may be arranged at least substantially without overlap in the axial direction. In this way, the advantages presented below are achieved. When the torsion spring is not under stress and the slot of the torsion spring is at its smallest, the two cams can be arranged axially behind each other because of the at least substantially overlap-free arrangement in the axial direction, and engage in the slot of the stress-free torsion spring. The smaller the slot, the stiffer the torsion spring may be. A further advantage may be that a radial drifting of the torsion spring under load is reduced. The smaller the slot, the lower the tendency of the torsion spring to drift radially. In other words, the disclosure allows as small as possible an opening angle between the two spring ends delimiting the slot.

If now the two spur gears are twisted relative to each other, the two cams press the spring ends apart, enlarging the slot. Because of the smaller slot with the arrangement according to the disclosure, torsion springs of the same size can have a better stiffness than with the known arrangement.

The term “substantially overlap-free” in the sense of the disclosure means for example that the two cams may have a step or stop at their mutually facing free ends which intermesh axially. These steps may be composed such that in one direction of rotation of the two spur gears, the steps meet each other with form-fit so that twisting in this direction is not possible. In this contact position, the two cams may be arranged lying perfectly axially behind each other, e.g., aligned with each other. In the opposite direction of rotation, a twisting of the spur gears is possible in order to set the desired pretension of the torsion spring.

It may however be favorable to arrange the cams completely overlap-free in the axial direction. This means that the two spur gears can be twisted in both directions of rotation in order to set the desired pretension of the torsion spring.

For mounting purposes, the two spur gears may be brought to a rotational position in which the two cams are arranged behind each other, e.g., without a peripheral offset to each other. In this position, the cams take up the smallest possible space in the peripheral direction; in this rotational position, the torsion spring may be arranged stress-free, wherein both cams engage in the slot of the torsion spring.

In one embodiment, both spur gears may be arranged on a common bearing bolt, wherein at least one of the two spur gears is arranged rotatably on the bearing bolt. The two spur gears may be identical in structure; the two spur gears may be arranged freely rotatably on the bearing bolt. The cams may be connected integrally with the assigned spur gear.

A further measure for improving the stiffness of the torsion spring may be that contact faces for the cams, formed on the two spring ends, are arranged on the radially outer end of the spring ends, wherein the contact faces are delimited radially inwardly by clearances at the spring ends. The further radially out the force application point lies, the stiffer the spring behaves, because of the lever ratios. The clearances ensure defined force application points radially on the outside.

The contact faces and the clearance faces forming the clearances may be arranged at an angle to each other, wherein an extension of the contact face in the radial direction lies in a region which accounts for at least 80% and most 100% of an external diameter of the torsion spring formed as a circular ring segment.

The load-free torsion spring with the respective contact face may span a flat face in which the rotation axis of the gear wheel also lies. In this case, an optimal force transmission in the circumferential direction can be ensured.

Also, at their peripheral ends, the cams with the respective flat cam faces may span a plane in which the rotation axis of the planet wheel lies.

The wall thickness of the torsion spring in the radial direction may have a great influence on its stiffness. For this reason, it is favorable to make optimal use of the installation space available. The torsion spring may therefore have an outer diameter which extends almost up to the tip circle diameter of the mating gear. The inner diameter of the torsion spring may extend almost up to the outer diameter of the bearing bolt on which the planet wheel is arranged. With this design, the torsion spring may have the maximum possible stiffness.

### BRIEF DESCRIPTION OF THE DRAWINGS

FIG. 1 shows an active roll stabilizer according to an embodiment of the disclosure,

FIG. 2 shows a planetary gear stage of the active roll stabilizer from FIG. 1,

FIG. 3 shows a cross-section through the planetary gear stage of FIG. 2,

FIG. 4 shows a partial longitudinal section through the planetary gear stage of FIG. 2,

FIG. 5 shows a planet wheel as depicted in FIG. 4,

FIG. 6 shows a front view of the planet wheel from FIG. 5,

FIG. 7 shows the planet wheel from FIG. 5 in an exploded view,

FIG. 8 shows a perspective view of the planet wheel from FIG. 5 in cross-section,

FIG. 9 shows an exploded view of the planet wheel as in FIG. 8,

FIG. 10 shows a section along line X-X from FIG. 5,

FIG. 11 shows a torsion spring of the planet wheel from FIG. 5,

FIG. 12 shows the torsion spring from FIG. 11 in perspective view, and

FIG. 13 shows a diagram with the pretension moment of the planet wheel over the twist angle.

### DETAILED DESCRIPTION

FIG. 1 shows an active roll stabilizer for a multitrack motor vehicle which has a torsion bar 3 divided into two torsion bar parts 1, 2, and an actuator 4 actively arranged between the two torsion bar parts 1, 2. This active roll stabilizer is arranged transversely to the vehicle longitudinal axis; its free ends are connected to wheel carriers (not shown). The actuator 4 has a hollow cylindrical housing 5 which houses an electric drive (not shown) and a planetary gear mechanism connected to the drive and not shown in detail. The housing 5 is connected rotationally fixedly to the torsion bar part 2. An output shaft (not shown) of the planetary gear mechanism is connected rotationally fixedly to the torsion bar part 1. When the actuator is activated, the two torsion bar parts 1, 2 are twisted relative to each other and a torsion moment is built up.

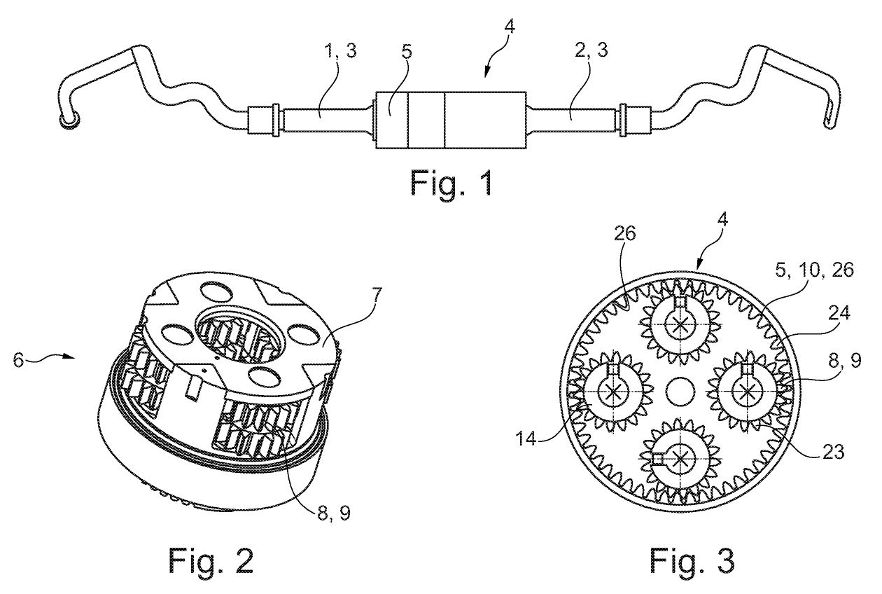

FIG. 2 shows a planetary gear stage 6 of said planetary gear mechanism. A planet wheel carrier 7 carries four gear wheels 8 which are distributed over the periphery and will be described in more detail below, and which are here used as planet wheels 9. The further description of the gear wheels 8 according to the disclosure is given with reference to these planet wheels 9.

FIG. 3 shows in cross-section the planetary gear stage 6 fitted in the housing 5. The planet wheels 9 with teeth 23 intermesh with teeth 24 of a mating gear 25, which is here formed as a ring gear 10 of the planetary gear mechanism and connected rotationally fixedly to the housing 5.

FIG. 4 shows a planet wheel 9 in longitudinal section. The planet wheel 9 has two axially adjacent spur gears 11 which, in the exemplary embodiment shown, are identical in structure. The two spur gears 11 are arranged rotatably on a bearing bolt 12 which is attached to the planet wheel carrier 7. The gear wheel may be asymmetric, so that one half is configured narrower. The cams may themselves also be asymmetric in both the peripheral direction and in their axial installation length.

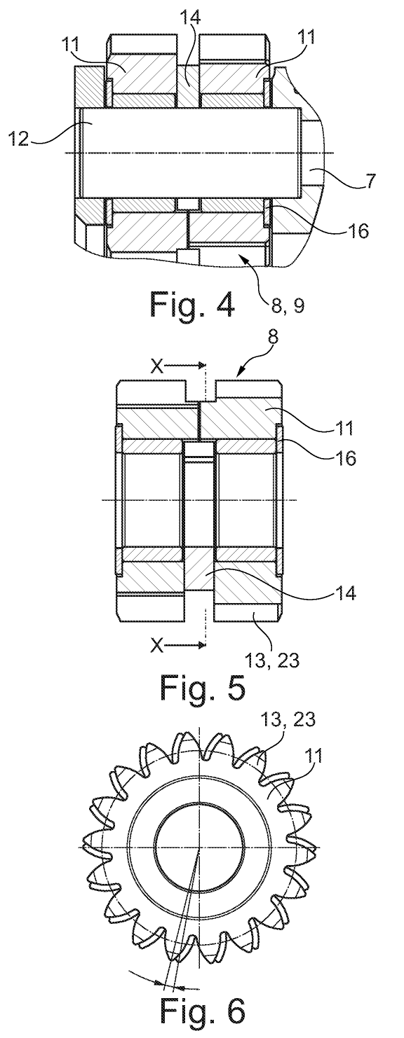

FIG. 5 shows the planet wheel 8 with its individual parts. On their outer periphery, the spur gears 11 have teeth 13 for engagement with the ring gear and with the sun wheel. A torsion spring 14 in the form of a circular ring segment is arranged between the two spur gears 11 and will be described in more detail below. The two spur gears 11 are provided with plain bearing bushes 15 for rotatable mounting on the bearing bolt. A thrust washer 16 is attached to each of the end faces of the spur gears 11 facing away from each other. Two axially adjacent teeth 13 of the two spur gears 11 together form one of the teeth 23 of the planet wheel 9.

The thrust washers in the gear wheels according to the disclosure may be omitted depending on application.

It can also be seen from FIG. 5 that the torsion spring 14 has an inner diameter which extends to the outer periphery of the bearing bolt (not shown here). The outer diameter of the torsion spring extends almost up to the tip circle diameter of the ring gear but does not collide with the teeth of the ring gear.

FIG. 6 shows the two spur gears 11 in a rotational position with the teeth 13 arranged offset. An initial twist φi between the two spur gears 11 is clearly evident. In the rotational position depicted, no pretension has yet been applied to the torsion spring 14; when the two spur gears 11 rotate further in the direction towards a rotational position in which the teeth 13 of the two spur gears 11 align, there is however an increase in a torque as the load of the torsion spring increases, up to a maximum moment Tmax with the teeth 13 axially aligned.

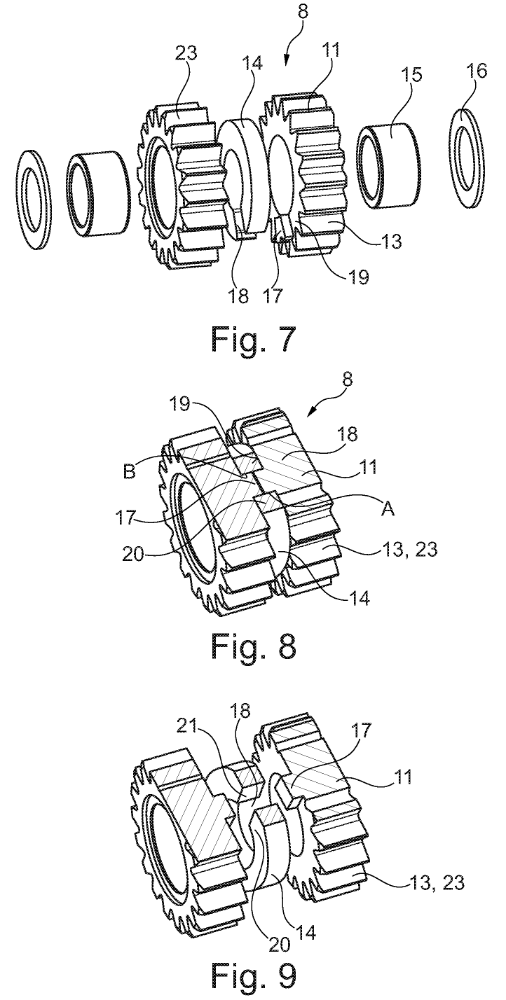

FIG. 7 clearly shows the individual parts of the planet wheel 9. Here it is evident that the spur gears 11 on the two mutually facing ends are each provided with an axially protruding cam 17 which is connected integrally to the assigned spur gear 11. The figure clearly shows the torsion spring 14, between the two peripherally opposing ends of which a slot 18 is formed in which the two cams 17 engage. The mutually facing ends of the two spur gears have bearing faces 19 for axial mounting of the torsion spring 14.

FIGS. 8 and 9 clearly show the engagement of the cams 17 in the slot 18 of the torsion spring 14. FIG. 8 in particular clearly shows that the two cams 17, between the bearing face 19 of the assigned spur gear 11 and the free cam end of this cam 17, jointly have an axial extension which is smaller than the axial extension of the torsion spring 14. If the torsion spring 14 is arranged axially play-free between the two spur gears 11, an axial distance is formed between the two cams 17, i.e. the cams 17 do not touch.

FIG. 9 clearly shows that the torsion spring 14 has an approximately rectangular cross-sectional profile which is arranged in the manner of an arc around the rotation axis of the planet wheel 9, wherein the torsion spring 14 is formed flat. The spring ends 20 of the torsion spring 14 have mutually facing contact faces 21 for the cams 17. The axial extension of these contact faces 21 corresponds to the axial thickness of the torsion spring 14.

Both contact faces 21 each overlap both cams 17 in the axial direction. The two cams 17 are arranged substantially axially aligned for mounting of the torsion spring 14. Depending on the design of the cams, a pretension of the torsion spring 14 can be set in both directions of rotation. The extension of the two cams 17 in the peripheral direction is slightly smaller than the extension of the slot 18 of the unloaded torsion spring 14. Consequently, assembly of the planet wheel 9 is simple. The peripheral play of the two cams 17 in the slot is dimensioned such that the spur gears 11 can twist relative to each other by an angle which is smaller than half the pitch of the spur gear.

In FIG. 8, the designations “A” and “B” indicate the contacts which exist between the torsion spring 14 and the two cams 17 when the torsion spring 14 is pretensioned. The two contact faces 21 formed at the spring ends 20 are loaded diagonally; in position “A”, the one cam 17 is in contact, and in position “B”, the other cam 17.

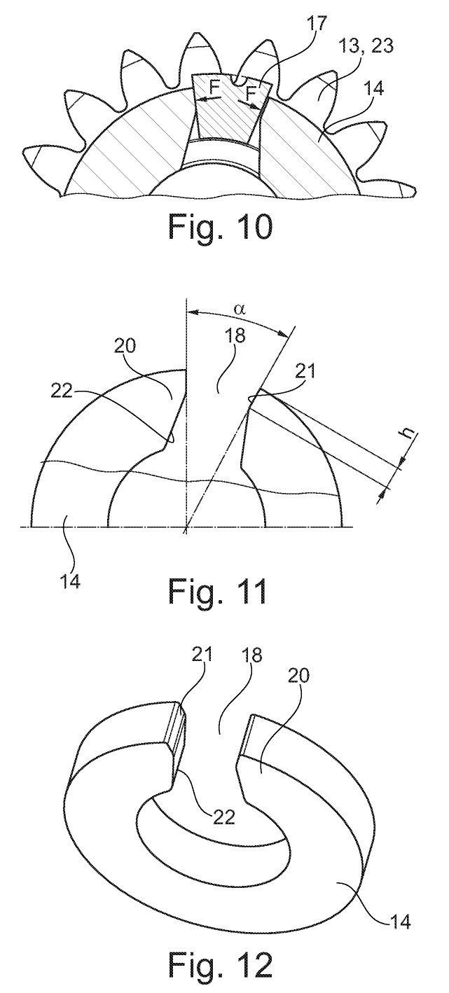

FIG. 10 shows a section through the planet wheel 9. This depiction shows that the force transmission between the cams 17 and the torsion spring 14 takes place on the radially outer portion of the torsion spring 14. The further radially outward the force transmission takes place, the stiffer the torsion spring 14 behaves and the more favorable the influence of the torsion spring 14 on reducing the disruptive rattling noise on a load change. Since the torsion spring 14 in deformed state is no longer perfectly circular, the contact point will drift radially outward, which benefits the stiffness of the torsion spring.

FIG. 11 shows the opening angle alpha between the two contact faces 21 of the torsion spring 14. The contact faces 21 enclosing the opening angle alpha evidently lie in a plane which contains the rotation axis of the gear wheel 8. In this position of the contact faces 21, the maximum possible force can be transmitted in the peripheral direction with a minimum possible radial force component.

The contact faces 21 extend over a height h which extends radially in a region as far radially out as possible at the spring end 20. In the exemplary embodiment, this region lies in a portion which amounts to between 80% and 100% of the outer diameter of the torsion spring 14. The further the attack point of the force is spaced radially from the rotation axis of the planet wheel 9, the better the torsion spring 14 can transmit the torque.

FIG. 12 shows the torsion spring in perspective view.

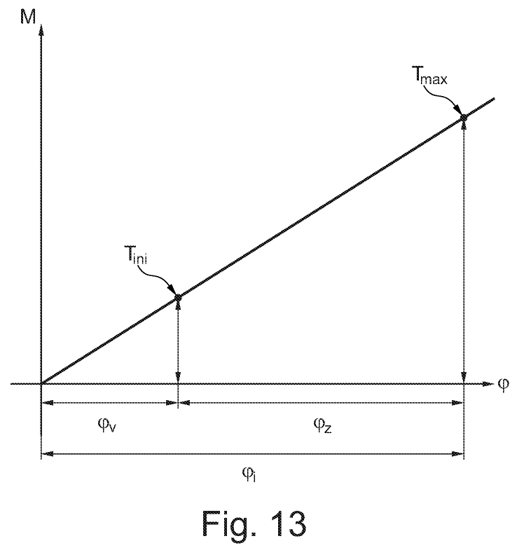

For the installation and function of the gear wheel according to the disclosure as a planet wheel in the planetary gear mechanism, reference is made to FIG. 13 which shows a torque loading of the torsion spring 14 over the twist angle between the two spur gears 11.

The initial twist φi of the two spur gears 11 (FIG. 6) represents the twist angle before these are joined to the ring gear and sun wheel. When the planet wheels 9 are joined to the sun wheel and ring gear using the planet carrier 7, the spur gears 11 are twisted relative to each other, since the initial twist φi is greater than the toothing play φz available between the planet wheel and the ring gear/sun wheel. The spur gears 11 are now twisted relative to each other by the pretension angle φv. A pretension moment Tini is set. The gear mechanism is now play-free. The travel still available is the toothing play φz. If the gear mechanism is now subjected to a moment, the spur gears twist further relative to each other until the tooth flanks make contact. During this process, the torsion spring is loaded to the maximum moment Tmax. This energy is now stored in the spring and reduces the impulse with which the tooth flanks can impact on each other. This effect is achieved by targeted matching of the spring stiffness and spring travel. The spring travel can be set using the toothing play.

The teeth 23 of the planet wheels 9 engage in the tooth gaps 25 of the ring gear 10 (FIG. 3). When the planetary gear mechanism is unloaded, firstly the one tooth 13 of the one spur gear 11 lies with pretension on the tooth 24 of the ring gear 10 delimiting the tooth gap 25; secondly, the other tooth 13 of the other spur gear 11 lies on the other tooth 24 of the ring gear 10 delimiting the tooth gap 25. If an operating load is now applied, the two spur gears 11 twist, with an increase in the torque acting between the two spur gears 11, until their teeth 13 are axially aligned and both lie with pretension on a common tooth 24 of the ring gear 10.

Similarly, the planet wheels 9 engage in the tooth gaps of the sun wheel so that play-free engagement of the planet wheels with the sun wheel is guaranteed.

### LIST OF REFERENCE SIGNS

1 Torsion rod part
2 Torsion rod part
3 Torsion rod
4 Actuator
5 Housing
6 Planetary gear stage
7 Planet wheel carrier
8 Gear wheel
9 Planet wheel
10 Ring gear
11 Spur gear
12 Bearing bolt
13 Teeth
14 Torsion spring
15 Plain bearing bush
16 Thrust washer
17 Cam
18 Slot
19 Bearing face
20 Spring end
21 Contact face
22 Clearance
23 Tooth (planet wheel)
24 Tooth (ring gear)
25 Tooth gap (ring gear)
26 Mating gear

1. A roll stabilizer for a multitrack motor vehicle, comprising:
a divided torsion bar having mutually facing ends, between which an actuator is arranged for transmission of a torsion moment, wherein the actuator has a housing which is connected to one torsion bar part and houses a motor and a planetary gear mechanism connected to the motor, a gear output of which is connected to the other torsion bar part and planet wheels of which intermesh with a mating gear,
wherein a multistage planetary gear mechanism is provided, whose final planetary gear stage on a gear output side is equipped with planet wheels, wherein at least one of said planet wheels is divided into two axially adjacent spur gears which are rotatable relative to each other and between which a torsion spring is actively arranged, such that a divided planet wheel is in play-free engagement with the mating gear.

2. The roll stabilizer as claimed in claim 1, wherein the torsion spring transmits a torsion moment between the two spur gears, under which torsion moment, when the roll stabilizer is load-free, firstly a tooth of one spur gear lies against a tooth of the mating gear delimiting a tooth gap, and secondly a tooth of the other spur gear lies against another tooth of the mating gear delimiting the tooth gap.

3. The roll stabilizer as claimed in claim 1, wherein the mating gear is formed by a ring gear connected rotationally fixedly to the housing.

4. The roll stabilizer as claimed in claim 1, wherein the planet wheels are mounted rotatably in a planet carrier and are all configured as divided planet wheels.

5. The roll stabilizer as claimed in claim 1, wherein the torsion spring is formed as a circular ring segment and has two peripheral spring ends, between which a slot is formed in which two cams engage which are each assigned to one of the two spur gears, wherein one cam is assigned to one of the two spring ends and the other cam is assigned to the other spring end.

6. The roll stabilizer as claimed in claim 5, wherein the two cams are arranged at least substantially without overlap in an axial direction.

7. The roll stabilizer as claimed in claim 6, wherein the two cams are arranged axially behind each other when the torsion spring is without load.

8. The roll stabilizer as claimed in claim 1, wherein the spur gears of a common planet wheel are mounted rotatably on a common bearing bolt.

9. The roll stabilizer as claimed in claim 5, wherein the two spur gears are identical in structure and wherein the two cams are each connected integrally to the assigned spur gear.
